(19) United States
(12) Patent Application Publication
(10) Pub. No.: US 2026/0292642 A1
(43) Pub. Date: Sep. 24, 2026

(54) RADIO LINK MONITORING BASED ON CROSS LINK INTERFERENCE REFERENCE SIGNALS

(71) Applicant: QUALCOMM Incorporated, San Diego, CA (US)

(72) Inventors: Vishnu Vardhan CHETLUR RAVI, San Diego, CA (US); Chiranjib SAHA, Lakeside, CA (US); Jae Ho RYU, San Diego, CA (US); Changhwan PARK, San Diego, CA (US)

(21) Appl. No.: 19/086,097

(22) Filed: Mar. 20, 2025

(51) Int. Cl. H04W 36/30; H04W 36/00

(52) U.S. Cl. CPC H04W 36/305; H04W 36/0088

(57) ABSTRACT

This disclosure provides methods, components, devices and systems for radio link monitoring based on cross link interference reference signals. For example, a first user equipment (UE) may declare a radio link failure (RLF) based on detecting one or more reference signals associated with interference from one or more second UEs. The first UE may receive, from one or more second UEs, one or more first reference signals associated with measurement of cross link interference (CLI) by the first UE. In response, the first UE may transmit, to a network entity, an indication of RLF associated with a communication link between the network entity and the first UE based on measurements of the one or more first reference signals (e.g., if at least one of the first reference signals satisfies one or more threshold measurements).

### TECHNICAL FIELD

This disclosure relates generally to wireless communication, and more specifically to systems, devices, methods, and techniques associated with radio link monitoring based on cross link interference reference signals.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a first UE is described. The method may include receiving configuration information associated with a set of first reference signals to be transmitted by one or more second UEs, where the set of first reference signals are associated with measurement of cross link interference (CLI) by the first UE, monitoring for the set of first reference signals from the one or more second UEs in accordance with the configuration information, and transmitting, to a network entity, an indication of radio link failure (RLF) associated with a communication link between the network entity and the first UE based on measurement of the set of first reference signals.

A first UE for wireless communications is described. The first UE may include a processing system that includes processor circuitry and memory circuitry that stores code. The processing system may be configured to cause the first UE to receive configuration information associated with a set of first reference signals to be transmitted by one or more second UEs, where the set of first reference signals are associated with measurement of CLI by the first UE, monitor for the set of first reference signals from the one or more second UEs in accordance with the configuration information, and transmit, to a network entity, an indication of RLF associated with a communication link between the network entity and the first UE based on measurement of the set of first reference signals.

Another first UE for wireless communications is described. The first UE may include means for receiving configuration information associated with a set of first reference signals to be transmitted by one or more second UEs, where the set of first reference signals are associated with measurement of CLI by the first UE, means for monitoring for the set of first reference signals from the one or more second UEs in accordance with the configuration information, and means for transmitting, to a network entity, an indication of RLF associated with a communication link between the network entity and the first UE based on measurement of the set of first reference signals.

A non-transitory computer-readable medium storing code for wireless communications is described. The code may include instructions executable by one or more processors (e.g., directly, indirectly, after pre-processing, without pre-processing) to receive configuration information associated with a set of first reference signals to be transmitted by one or more second UEs, where the set of first reference signals are associated with measurement of CLI by the first UE, monitor for the set of first reference signals from the one or more second UEs in accordance with the configuration information, and transmit, to a network entity, an indication of RLF associated with a communication link between the network entity and the first UE based on measurement of the set of first reference signals.

In some examples of the method, first user equipment (UEs), and non-transitory computer-readable medium described herein, transmitting the indication of RLF may include operations, features, means, or instructions for transmitting the indication of RLF based on one or more metrics associated with at least one first reference signal of the set of first reference signals satisfying one or more first thresholds, where the one or more metrics may be based on measurement of the set of first reference signals.

Some examples of the method, first user equipment (UEs), and non-transitory computer-readable medium described herein may further include operations, features, means, or instructions for monitoring, from the network entity via the communication link, for a set of second reference signals, where the set of second reference signals may be associated with one or more second thresholds for detection of RLF on the communication link.

Some examples of the method, first user equipment (UEs), and non-transitory computer-readable medium described herein may further include operations, features, means, or instructions for transmitting, from a physical layer of the first UE to a radio resource control layer of the first UE, one or more consecutive out-of-sync indications based on the one or more metrics satisfying the one or more first thresholds, where transmission of the indication of RLF may be based on a quantity of the one or more consecutive out-of-sync indications exceeding a second threshold.

Some examples of the method, first user equipment (UEs), and non-transitory computer-readable medium described herein may further include operations, features, means, or instructions for transmitting, from a physical layer of the first UE to a radio resource control layer of the first UE, one or more consecutive indications of detected CLI associated with the one or more second UEs based on the one or more metrics satisfying the one or more first thresholds, where transmission of the indication of RLF may be based on the one or more consecutive indications of CLI.

In some examples of the method, first user equipment (UEs), and non-transitory computer-readable medium described herein, the configuration information indicates one or more resources that the first UE may be to use for monitoring for the set of first reference signals and monitoring for the set of first reference signals may be via the one or more resources.

### BRIEF DESCRIPTION OF THE DRAWINGS

FIG. 1 shows an example of a wireless communication system.

FIG. 2 shows an example of a signaling diagram that supports radio link monitoring (RLM) based on cross link interference reference signals.

FIG. 3 shows an example of a wireless communications system that supports RLM based on cross link interference reference signals.

FIG. 4 shows a block diagram of a processing system that supports RLM based on cross link interference reference signals.

FIG. 5 shows a diagram of a system including a device that supports RLM based on cross link interference reference signals.

FIG. 6 shows a flowchart illustrating methods that support RLM based on cross link interference reference signals.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications systems, a coverage area of an NTN may overlap (e.g., encompass) with a coverage area of a terrestrial network (TN). Such an overlap may cause cross link interference (CLI) if one or more first UEs associated with the NTN (e.g., secondary network users, NTN UEs) use supplementary coverage by sharing a portion of a frequency range (e.g., spectrum, bandwidth) with one or more second UEs associated with the TN (e.g., primary network users, TN UEs). That is, CLI (e.g., cross-link co-channel interference) may occur between downlink communications received by the one or more first UEs from a first network entity associated with the NTN and uplink communications transmitted by the one or more second UEs to a second network entity associated with the TN (e.g., or visa-versa) based on the downlink communications and the uplink communications sharing a same set of time and frequency resources. In such cases, the one or more first UEs may be unable to mitigate or resolve the CLI.

Aspects of the subject matter described in this disclosure relate to a first UE (e.g., an NTN UE) declaring (e.g., transmitting an indication of) RLF based on detecting (e.g., sensing) one or more reference signals associated with interference from one or more second UEs (e.g., TN UEs), such as a cross link interference (CLI) sounding reference signal (CLI-SRS). The first UE may receive an SRS configuration (e.g., indicative of one or more resources) associated with the CLI-SRSs to be transmitted by the one or more second UEs, where the CLI-SRSs are associated with measurement of CLI by the first UE, such that the first UE may receive, from the one or more second UEs, the CLI-SRSs in accordance with the SRS configuration (e.g., via the one or more resources).

In some cases, in response to receiving the CLI-SRSs, the first UE may transmit, to a network entity, an indication of RLF on a communication link between the network entity and the first UE based on measurement of the CLI-SRSs. For example, the first UE may transmit the indication of RLF if respective measurements of the CLI-SRSs satisfy one or more threshold measurements, which may indicate that communications by the first UE may cause CLI with communications by the one or more second UEs (e.g., CLI occurs between the communications by the first UE and the communications by the one or more second UEs). In such cases, the indication of RLF may further indicate a cause of the RLF, where the cause corresponds to the RLF being based on CLI with the one or more second UEs. Thus, during a cell re-selection procedure after declaring RLF, the first UE may refrain from selecting the network entity due to communications with the network entity experiencing (e.g., causing) CLI with the one or more second UEs. Accordingly, declaring RLF based on CLI from one or more second UEs may enable the first UE to mitigate the CLI and more efficiently resume communications.

Particular aspects of the subject matter described in this disclosure can be implemented to realize one or more of the following potential advantages. In some examples, by declaring RLF based on CLI, the described techniques can be used to reduce interference between NTN UEs and TN UEs using a same spectrum. Further, these techniques may improve an ability of a UE (e.g., an NTN UE) to select cells for communication that do not cause interference for other UEs. Accordingly, these techniques may improve communication reliability and efficiency for wireless devices.

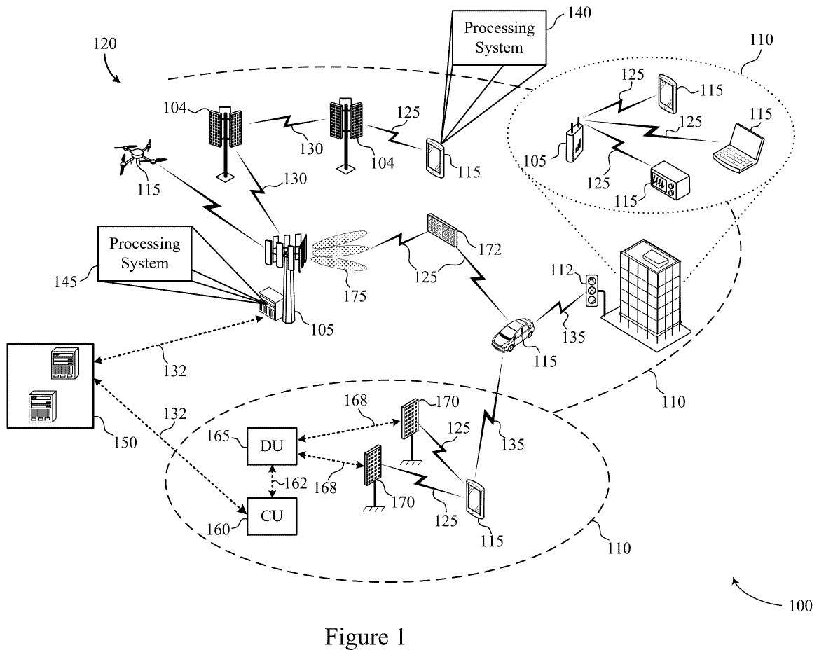

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet device, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, SRSs that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

In some cases, a UE 115 may perform radio link monitoring (RLM) based on different RLM reference signal (RLM-RS) resources, as configured by a network entity 105 (e.g., through an RRC message in RadioLinkMonitoringConfig). For example, the UE 115 may monitor for one or more synchronization signal/PBCH blocks (SSBs), one or more CSI-RSs, or a combination of SSBs and CSI-RSs. A physical layer of the UE 115 may transmit (e.g., indicate), to one or more higher layers of the UE 115 (e.g., an RRC layer), one or more indications (e.g., out-of-sync or in-sync indications) in one or more frames where a radio link quality is assessed. The physical layer may transmit such indications if the radio link quality satisfies one or more thresholds for a set of resources for RLM. The one or more thresholds may include one or more out-of-sync thresholds (e.g., Qout) and one or more in-sync thresholds (e.g., Qin). An out-of-sync threshold (e.g., Qout) may be defined as a level at which the UE 115 is unable to reliably receive a downlink radio link and may correspond to an out-of-sync block error rate (BLER) (e.g., BLERout). In some examples, the UE 115 may derive (e.g., calculate, generate) an out-of-sync threshold (e.g., Qout) for one or more reference signals (e.g., SSB, CSI-RS) based on one or more hypothetical downlink transmission parameters (e.g., PDCCH transmission parameters) of the one or more reference signals. Similarly, an in-sync threshold (e.g., Qin) may be defined as a level at which the UE 115 may receive the downlink radio link with relatively high reliability (e.g., than at Qout). The in-sync threshold may correspond to an in-sync BLER (e.g., BLERin). For example, the out-of-sync BLER may be 10% while the in-sync BLER may be 2%, according to one configuration. In some cases, the UE 115 may determine BLERout and BLERin based on one or more network configurations via one or more parameters (e.g., rlmInSyncOutOfSyncThreshold) signaled by one or more higher layers. If the UE is not configured with the one or more parameters, the UE 115 may determine BLERout and BLERin based on one or more parameters pre-configured at the UE 115.

In some wireless communications systems, an RRC layer (e.g., a higher layer) of the UE 115 may transmit one or more configurations to a physical layer (e.g., a lower layer) of the UE 115. The one or more configurations may include a configuration for monitoring reference signals, a resource configuration for the monitoring, a configuration for in-sync and out-of-sync thresholds, or any combination thereof. The UE may monitor for reference signals at the physical layer. Then, the RRC layer may receive one or more in-sync indications, one or more out-of-sync indications, or both from the physical layer (e.g., in accordance with the one or more configurations.

In some wireless communications systems, if a UE 115 fails to receive an RLM reference signal configuration (e.g., RadioLinkMonitoringRS) from a network entity 105, the UE 115 may use one or more reference signals provided for one or more active transmission configuration indicator (TCI) states for one or more control resource sets (CORESETs) for physical downlink control channel (PDCCH) reception. If the one or more active TCI states for PDCCH reception includes two (or more) reference signals, the UE 115 may expect that one reference signal has a given type of quasi co-location (QCL) (e.g., QCL-TypeD). In such cases, the UE 115 may use the reference signal that has the given type of QCL for RLM. In some examples, the UE 115 may receive either a CSI-RS resource configuration index (e.g., by csi-RS-Index), or an SSB index (e.g., by ssb-Index). In some cases, the UE 115 may be configured with a quantity (e.g., N_{LR-RLM}) of RLM reference signals (e.g., RadioLinkMonitoringRS) for link recovery and RLM. From the quantity of RLM reference signals, the UE 115 may use a threshold quantity (e.g., N_{RLM}) of reference signals (e.g., from the N_{LR-RLM} reference signals_ for RLM depending on a threshold (e.g., maximum) quantity (e.g., Lₘₐₓ) of candidate SSBs per half frame. Additionally, or alternatively, the UE 115 may use up to two RLM reference signals for link recovery procedures.

In some examples, a UE 115 may detect (e.g., declare) RLF in response to an expiration of one or more timers, including a first timer (e.g., T310), a second timer (T312), or both. In some cases, the UE 115 may start the first timer in response to receiving, at an RRC layer, a first threshold quantity (e.g., N310) of consecutive out-of-sync indications from one or more lower layers of the UE (e.g., physical layer). The UE 115 may stop the first timer in response to receiving a second threshold quantity (e.g., N311) of consecutive in-sync indications from the one or more lower layers. Additionally, or alternatively, the UE 115 may stop the first timer in response to a trigger for a handover procedure or in response to initiating a connection re-establishment procedure. At an expiration of the first timer, the UE 115 may enter an idle (e.g., RRC_IDLE) mode, if a particular security feature (e.g., access stratum security) is not activated at the UE 115. Otherwise, at the expiration of the first timer, the UE 115 may initiate a connection re-establishment procedure or a master cell group (MCG) or secondary cell group (SCG) failure information procedure (e.g., an MCG/SCG failure information procedure).

In some wireless communications systems, an NTN may support (e.g., complement) coverage and resilience of a TN. For example, an NTN may offer comprehensive coverage and disaster resilience to UEs 115 within the NTN while a TN may have a relatively high throughput capacity (e.g., compared to the NTN). Further, due to a relatively low cost of low earth orbit (LEO) launches (e.g., in recent years), TNs may have an opportunity to use resources and benefits offered by NTNs. However, an NTN spectrum (e.g., in a first frequency range, FR1) may be relatively scarce and may be subject to one or more regulation limits (e.g., due to incumbent terrestrial communication services).

In some wireless communications systems, a TN may share a spectrum (e.g., frequency range) with an NTN. Such spectrum sharing may result in potential CLI (e.g., cross-link co-channel interference when NTN UEs 115 use supplementary coverage by sharing spectrum with TN UEs 115). For example, signaling from a TN UE 115 may cause interference to an NTN UE 115, and visa-versa. That is, CLI may occur between downlink communications (e.g., an NTN downlink signal) received by an NTN UE 115 from a first network entity associated with an NTN (e.g., NTN network entity) and uplink communications (e.g., a TN uplink signal) transmitted by a TN UE 115 to a second network entity associated with a TN (e.g., TN network entity, or visa-versa) when the downlink communications and the uplink communications share a same set of resources (e.g., a same time and frequency resource). Such CLI may occur due to the downlink communications and the uplink communications sharing a same set of time and frequency resources. In such cases, the NTN UE 115 may be unable to mitigate or resolve the CLI. Accordingly, spectrum sharing between an NTN and a TN with a same link allocation may result in inefficiencies due to interference (e.g., satellite or NTN downlink to TN downlink interference).

The wireless communications system 100 may support a first UE 115 (e.g., an NTN UE 115) that declares an RLF based on detecting (e.g., sensing) one or more reference signals associated with interference from one or more second UEs 115 (e.g., TN UEs 115), such as a CLI-SRS. The first UE 115 may receive configuration information (e.g., indicative of one or more resources) associated with one or more first reference signals (e.g., CLI-SRSs) to be transmitted by the one or more second UEs 115. The one or more first reference signals may be associated with measurement of CLI by the first UE 115. The first UE 115 may receive, from the one or more second UEs 115, the one or more first reference signals in accordance with the configuration information (e.g., via the one or more resources).

In some cases, in response to receiving the one or more first reference signals, the first UE 115 may transmit, to a network entity 105 associated with the first UE 115 (e.g., an NTN network entity 105), an indication of RLF associated with a communication link between the network entity 105 and the first UE 115 based on measurement of the one or more first reference signals. For example, the first UE 115 may transmit the indication of RLF if respective measurements of the one or more first reference signals satisfy one or more threshold measurements. The indication of RLF may indicate that communications by the first UE 115 and communications by the one or more second UEs 115 may interfere. In such cases, the indication of RLF may further indicate that the RLF is based on CLI from the one or more second UEs 115.

Thus, during a cell re-selection procedure after declaring RLF, the first UE 115 may refrain from selecting the network entity 105 due to communications with the network entity 105 experiencing CLI with the one or more second UEs 115. Accordingly, declaring RLF based on CLI with the one or more second UEs 115 may enable the first UE 115 to mitigate the CLI and to resume communications more efficiently. As described herein, “declaring an RLF” may refer to transmitting an RLF report (and one or more indications associated with RLF) to a network entity 105. The techniques described herein may improve an ability of a UE 115 (e.g., an NTN UE 115) to select cells for communication that do not cause interference for other UEs 115. Accordingly, these techniques may improve communication reliability and efficiency for wireless devices.

Devices of the wireless communication system 100 may be configured to support one or more aspects of the described techniques for RLM based on CLI reference signals. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support declaring RLF based on CLI, which may reduce interference between NTN UEs and TN UEs using a same spectrum.

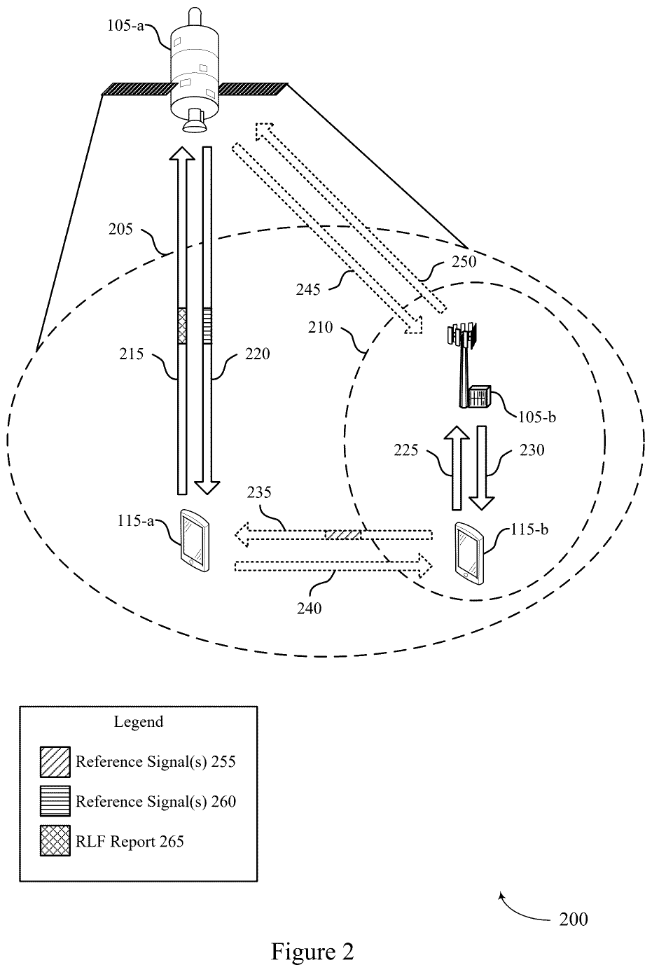

FIG. 2 shows an example of a signaling diagram 200 that supports RLM based on CLI reference signals. In some cases, the signaling diagram 200 may implement or be implemented by aspects of the wireless communications system 100. For example, the signaling diagram 200 may include one or more UEs 115 (e.g., a UE 115-a and a UE 115-b) and one or more network entities 105 (e.g., a network entity 105-a and a network entity 105-b), which may be examples of the corresponding devices as described herein. The network entity 105-a may be an example of an NTN network entity (e.g., a satellite entity, a LEO network entity, an NTN cell) and the network entity 105-b may be an example of a TN network entity (e.g., a TN cell). Accordingly, as described herein, the UE 115-a may be an example of an NTN UE 115 (e.g., a UE 115 supported by an NTN) and the UE 115-b may be an example of a TN UE 115 (e.g., a UE 115 supported by a TN). The network entity 105-b may serve a coverage area 205 (e.g., an NTN coverage area) including the UE 115-a (and potentially the network entity 105-b and the UE 115-b). Similarly, the network entity 105-b may serve a coverage area 210 (e.g., a TN coverage area) supporting the UE 115-b. In some cases, the coverage area 210 may overlap with the coverage area 205 (e.g., coverage area 205 may encompass the coverage area 210).

In some implementations, each entity within the signaling diagram 200 may communicate with other entities through respective wireless communication links. For example, the UE 115-a may transmit signaling to the network entity 105-a via a wireless communication link 215 and may receive signaling from the network entity 105-a via a wireless communication link 220. Similarly, the UE 115-b may transmit signaling to the network entity 105-b via a wireless communication link 225 and may receive signaling from the network entity 105-b via a wireless communication link 230. Each entity may also experience potential interference from other entities within the signaling diagram 200. For example, signaling between the UE 115-b and the network entity 105-b may cause interference 235 (e.g., CLI) with the UE 115-a, interference 250 with the network entity 105-a, or both. Similarly, signaling between the UE 115-a and the network entity 105-a may cause interference 240 with the UE 115-b, interference 245 with the network entity 105-b, or both.

In some implementations, the UE 115-a may receive one or more reference signals 260 from the network entity 105-a. Similarly, the UE 115-a may receive one or more reference signals 255 (e.g., a new, second reference signal for RLM) from the UE 115-b (e.g., a UE 115 in a TN, a TN UE 115). The one or more reference signals 255 may include RLM reference signals (e.g., RLM-RS2), reference signals for detecting CLI (e.g., CLI-SRS), or both. In some cases, as described herein, terms such as RLM-RS2 and CLI-SRS may be used interchangeably. In some examples, the one or more reference signals 255 may be an optional element of the signaling diagram 200. The one or more reference signals 260 may include one or more SSBs or CSI-RSs. In some implementations, the UE 115-a (e.g., an NTN UE 115) may declare RLF in response to detecting a presence of TN UEs 115 (e.g., the UE 115-b) in a shared spectrum with the UE 115-a. The one or more reference signals 255 may be configured with multiple CLI-SRS resources. In some cases, an SRS configuration (e.g., configuration of the one or more reference signals 255) of one or more TN UEs 115 (e.g., the UE 115-b) may be signaled (e.g., from the network entity 105-a) to an NTN UE 115 (e.g., the UE 115-a).

In some implementations, the UE 115-a may have one or more scheduling configurations (e.g., restrictions) associated with monitoring for the one or more reference signals 255 during RLM (e.g., scheduling restrictions for frequency domain duplexing FR1). In some cases, the UE 115-a and the UE 115-b may not be synchronized with respect to time and frequency. In such cases, the UE 115-a may use additional time and frequency resources to search for symbols of the one or more reference signals 255 (e.g., CLI-SRS symbols). Accordingly, the UE 115-a may not expect downlink scheduling during an RLM procedure.

The signaling diagram 200 may support one or more techniques (e.g., alternatives) for an RLF detection procedure (e.g., a procedure for determining whether to declare RLF) based on the one or more reference signals 255. The RLF detection procedure may include determining whether to transmit an RLF report 265 to the network entity 105-a based on the one or more reference signals 255. The RLF report 265 may include an indication of an RLF associated with the network entity 105-a.

In some cases, an RRC layer of the UE 115-a may receive out-of-sync and in-sync indications output from one or more lower layers (e.g., a physical layer) of the UE 115-a based on radio link quality measured using the one or more reference signals 260 (e.g., SSB, CSI-RS, or both). Additionally, or alternatively, in accordance with a first alternative for the RLF detection procedure, the UE 115-a may determine out-of-sync and in-sync indications by also including the one or more reference signals 255. That is, the UE 115-a may generate an out-of-sync indication based on a radio link quality of a reference signal 260 or based on a radio link quality of a reference signal 255. The UE 115-a may derive (e.g., generate, calculate, determine) Qin and Qout thresholds for the one or more reference signals 255 based on BLER configurations (e.g., requirements) corresponding to the one or more reference signals 255, which may be different from BLER configurations of the one or more reference signals 260. Accordingly, the UE 115-a may determine whether to declare RLF (e.g., whether to transmit the RLF report 265) using a physical layer and an RRC layer of the UE 115-a based on the one or more reference signals 260, the one or more reference signals 255, or both.

As described herein, a Qin threshold may correspond to a radio link quality corresponding to an in-sync state of the UE 115-a, while a Qout threshold may correspond to a radio link quality corresponding to an out-of-sync state of the UE 115-a. In accordance with the first alternative, the UE 115-a may have a first set of Qin and Qout thresholds associated with measurement of the one or more reference signals 260 and a second set of Qin and Qout thresholds associated with measurement of the one or more reference signals 260 and the one or more reference signals 255. The UE 115-a may use the first set or the second set based on an RRC configuration of a set of received reference signals (e.g., the UE 115-a may use the second set if RLM-RS2 or CLI-SRS is present).

In some cases, first set of Qin and Qout thresholds may be different than the second set of Qin and Qout thresholds. In such cases, the UE 115-a may generate an out-of-sync indication based on a radio link quality of a reference signal 260 exceeding a first Qout threshold (e.g., of the first set of Qin and Qout thresholds) or may generate an out-of-sync indication based on a radio link quality of a reference signal 255 exceeding a second Qout threshold (e.g., of the second set of Qin and Qout thresholds). In some other cases, the first set of Qin and Qout thresholds may be the same as the second set of Qin and Qout thresholds. In such cases, the UE 115-a may generate an out-of-sync indication based on either a radio link quality of a reference signal 260 or a radio link quality of a reference signal 255 exceeding a same Qout threshold.

In accordance with the first alternative, the UE 115-a may include a first set of logic that is based on the first set of Qin and Qout thresholds and measurement of the one or more reference signals 260. The first set of logic may output one or more in-sync and out-of-sync indications associated with the one or more reference signals 260. The UE 115-a may further include a second set of logic that is based on the second set of Qin and Qout thresholds and measurement of the one or more reference signals 255 (or measurement of both the one or more reference signals 260 and the one or more reference signals 255). The second set of logic may output one or more in-sync and out-of-sync indications associated with the one or more reference signals 255 (e.g., CLI-SRS indications). For the second set of logic, the UE 115-a may derive a hypothetical BLER (e.g., for the one or more reference signals 255) in accordance with a metric that is based on a signal-to-interference-and-noise ratio (SINR) associated with the one or more reference signals 255. A signal metric of the SINR may be based on the one or more reference signals 260 (e.g., the SSB or CSI-RS). An interference metric of the SINR may be based on a configured TN CLI-SRS (e.g., a configuration from one or more network entities 105 as described herein).

In accordance with a second alternative for the RLF detection procedure, the UE 115-a may support indications associated with the one or more reference signals 255 from the one or more lower layers of the UE 115-a (e.g., a physical layer). For example, the UE 115-a (e.g., the RRC layer of the UE 115-a) may receive out-of-sync indications and in-sync indications from the one or more lower layers based on the one or more reference signals 260. Additionally, or alternatively, the UE 115-a may receive a third indication (e.g., “new indications”) based on the one or more reference signals 255 (e.g., an indication that CLI is present, such as CLI-present or CLI-SRS detected, or an indication that CLI is absent, such as CLI-absent or CLI-SRS not detected).

In some implementations, the UE 115-a may modify one or more start and stop conditions for one or more timers (e.g., T310 and T312) based on the one or more reference signals 255. At an expiry of the one or more timers, the UE 115-a may detect (e.g., determine, declare) an RLF associated with the network entity 105-a. In response, the UE 115-a may enter an idle mode (e.g., RRC_IDLE) if a security feature (e.g., access stratum security) is not activated (e.g., enabled). For example, the UE 115-a may start a first timer (e.g., T310) in response to detecting a first threshold quantity (e.g., N_SRS1) of consecutive indications that CLI is present (e.g., consecutive CLI-present signals) from a physical layer of the UE 115-a. The UE 115-a may stop the first timer in response to detecting a second threshold quantity (e.g., N_SRS2) of consecutive indications that CLI is absent (e.g., consecutive CLI-absent signals) from the physical layer. Accordingly, the physical layer may send, to an upper layer (e.g., RRC layer) of the UE, indications of whether CLI was detected at the physical layer (e.g., based on the one or more reference signals 255).

In response, the upper layer (e.g., RRC layer) may receive the indications and may modify the one or more start and stop conditions for the one or more timers associated with RLF (e.g., T310 and T312). For example, the first timer (e.g., T310) may start in response to receiving a threshold quantity (e.g., N310) of consecutive out-of-sync indications from the one or more lower layers (e.g., in response to detecting physical layer problems for a special cell associated with the UE 115-a). Additionally, or alternatively, the first timer may start in response to a threshold quantity (e.g., N310-x) of consecutive CLI-present indications from the one or more lower layers. In some implementations, the UE 115-a may stop the first timer in response to receiving a threshold quantity (e.g., N311) of consecutive in-sync indications from the one or more lower layers for the special cell. Additionally, or alternatively, the UE 115-a may stop the first timer in response to receiving a threshold quantity (e.g., N311-x) of consecutive in-sync indications and a threshold quantity of consecutive CLI-absent indications from lower layers.

In accordance with a third alternative for the RLF detection procedure, the UE 115-a may use one or more timers (e.g., T3xx) associated with CLI detection based on the one or more reference signals 255 (e.g., in addition to, and different than, the one or more timers associated with RLF). The UE 115-a may start and stop the one or more timers associated with CLI detection according to one or more start and stop conditions (e.g., in response to receiving one or more indications associated with CLI from the one or more lower layers as described herein). In some examples, the UE 115-a may start the one or more timers associated with CLI detection in response to receiving a threshold quantity (e.g., N310-x) of consecutive CLI-present (e.g., CLI-SRS-detected) signals from the one or more lower layers. The UE 115-a may stop the one or more timers in response to receiving a threshold quantity (e.g., N311-x) of consecutive CLI-absent (e.g., CLI-SRS-not-detected) indications from the one or more lower layers for the special cell. In response to an expiration of the one or more timers associated with CLI, the UE 115-a may declare RLF (e.g., transmit the RLF report 265 to the network entity 105-a). In some cases, after declaring RLF, the UE 115-a may refrain from attempting connection re-establishment (the UE 115-a having determined to be in a shared spectrum with the UE 115-b). Additionally, or alternatively, the UE 115-a may enter an idle mode based on expiration of the one or more timers.

In some implementations, the UE 115-a may perform one or more operations in response to detecting and declaring an RLF in response to CLI based on the one or more reference signals 255. For example, the UE 115-a may differentiate an RLF that is due to the one or more reference signals 255 (e.g., due to CLI) from another RLF event that does not involve CLI. In some cases, the UE may include, in the RLF report 265 (e.g., VarRLFReport), a cause value that indicates that the RLF associated with the RLF report 265 was due to CLI (e.g., a cause value such as CLI-SRS detected or CLI detected). In some examples, the UE 115-a may perform a cell reselection procedure while a second timer (e.g., T311), associated with the one or more reference signals 260, is running after an expiration of the one or more timers (e.g., T310) associated with the one or more reference signals 255. During the cell reselection procedure, the UE 115-a may consider the network entity 105-a (e.g., cell) associated with the RLF as a barred network entity 105-a (e.g., with uplink restrictions) for the cell reselection procedure. That is, the UE 115-a may refrain from selecting the network entity 105-a during the cell reselection procedure based on declaring RLF with the network entity 105-a. In some implementations, the UE 115-a may indicate a radio capability message to the network entity 105-a. The radio capability message may indicate a radio capability of the UE 115-a to declare RLF based on a measurement of the one or more reference signals 255 (e.g., based on CLI detection). Accordingly, the signaling diagram 200 may support techniques that result in reduced signal interference between devices, improved coordination between devices, and more efficient use of communication resources, among other advantages.

Though described in the context of alternatives (e.g., a first alternative, a second alternative, a third alternative), this is not to be regarded as a limitation of the present disclosure. In this regard, the techniques described herein may be used in any combination of ways, such that one or more of the alternatives may be supported, or implemented, by the UE 115-a simultaneously.

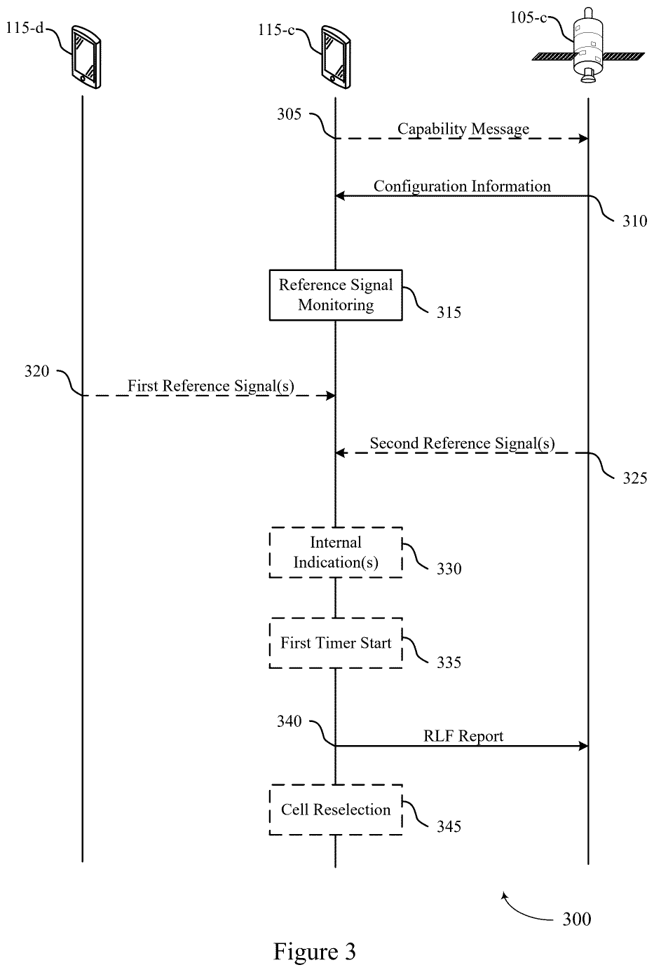

FIG. 3 shows an example of a process flow 300 that supports RLM based on CLI reference signals. The process flow 300 includes a UE 115-c, a UE 115-d, and a network entity 105-c, which may be examples of the corresponding devices as described with respect to FIGS. 1 and 2. In the following description of the process flow 300, the operations between the UE 115-c, the UE 115-d, and the network entity 105-c may be performed in a different order than the example order shown. Some operations may also be omitted from the process flow 300, and other operations may be added to the process flow 300. Further, although some operations or signaling may be shown to occur at different times for discussion purposes, these operations may actually occur at the same time. As described herein, the UE 115-c may be associated with an NTN and the UE 115-d may be associated with a TN. The network entity 105-c may be associated with the NTN.

At 305, the UE 115-c may transmit, to the network entity 105-c, a capability message indicative of one or more capabilities of the UE 115-c to declare RLF based on measurement of a set of first reference signals (e.g., a set of one or more first reference signals, CLI-SRSs) to be transmitted by one or more second UEs 115 (e.g., the UE 115-d). The set of first reference signals may be associated with measurement of CLI by the UE 115-c.

At 310, the UE 115-c may receive configuration information from the network entity 105-c (e.g., in response to the capability message). The configuration information may be associated with the set of first reference signals. In some cases, the UE 115-c may receive the configuration information based on transmitting the capability message. In some cases, the configuration information may indicate one or more first thresholds for detection of RLF on a communication link between the UE 115-c and the network entity 105-c. The one or more first thresholds may be associated with detection of RLF based on CLI. In some implementations, the configuration information may indicate one or more resources that the UE 115-c is to use for monitoring for the set of first reference signals. In some examples, the one or more resources may be restricted from being scheduled with one or more downlink messages, one or more uplink messages, or both, based on the one or more resources being used for monitoring for the set of first reference signals.

At 315, the UE 115-c may monitor (e.g., monitor for) the set of first reference signals from the one or more second UEs 115 in accordance with the configuration information. In some cases, the UE 115-c may monitor for the set of first reference signals via the one or more resources (e.g., indicated in the configuration information). Similarly, at 315, the UE 115-c may monitor for a set of second reference signals (e.g., a set of one or more second reference signals, RLM-RSs) from the network entity 105-c.

At 320, the UE 115-c may receive the one or more first reference signals from the one or more second UEs 115 (e.g., the UE 115-d). In some cases, at 325, the UE 115-c may additionally receive the set of second reference signals via the communication link between the UE 115-c and the network entity 105-c. The set of second reference signals may be associated with one or more second thresholds for detection of RLF on the communication link. In some cases, the configuration information may indicate the one or more second thresholds.

In some implementations, the one or more first thresholds may be the same as the one or more second thresholds or may be different than the one or more second thresholds. In some examples, the one or more first thresholds may be based on one or more first BLER thresholds associated with the set of first reference signals and the one or more second thresholds may be based on one or more second BLER thresholds associated with the set of second reference signals, where the one or more first thresholds may be different than the one or more second thresholds based on the one or more first BLER thresholds being different than the one or more second BLER thresholds.

At 330, the UE 115-c may perform one or more internal indication procedures. For example, the UE 115-c may transmit, from a physical layer to an RRC layer of the UE 115-c, one or more consecutive out-of-sync indications. The UE 115-c may transmit the one or more consecutive out-of-sync indications based on one or more metrics associated with at least one first reference signal of the set of first reference signals satisfying the one or more first thresholds. Additionally, or alternatively, the UE 115-c may transmit, from the physical layer to the RRC layer, one or more consecutive indications of detected CLI associated with the one or more second UEs 115. The UE 115-c may transmit the one or more indications of detected CLI based on the one or more metrics satisfying the one or more first thresholds.

At 335, the UE 115-c may optionally start a first timer at the RRC layer. The UE 115-c may start the first timer based on receipt of the one or more consecutive indications of detected CLI. In some cases, the first timer may be different than one or more second timers associated with detection of RLF based on the set of second reference signals received from the network entity 105-c. Additionally, or alternatively, the first timer may be associated with detection of RLF based on the set of second reference signals received from the network entity 105-c (e.g., the first timer may be one of the one or more second timers).

At 340, the UE 115-c may transmit an RLF report to the network entity 105-c. In some cases, the RLF report may include an indication of RLF associated with the communication link between the network entity 105-c and the UE 115-c. The UE 115-c may transmit the indication of RLF (e.g., declare RLF) based on measurement of the set of first reference signals. In some implementations, the UE 115-c may transmit the indication of RLF based on the one or more metrics associated with the at least one first reference signal of the set of first reference signals satisfying the one or more first thresholds. The one or more metrics may be based on measurement of the set of first reference signals. In some examples, the RLF report message may be indicative of a cause value associated with the RLF (e.g., indicating a cause of the RLF). The cause value may indicate that the RLF is (or was) based on CLI associated with the set of first reference signals.

In some implementations, the UE 115-c may transmit the indication of RLF based on a quantity of the one or more consecutive out-of-sync indications satisfying (e.g., exceeding) a second threshold. In some cases, the UE 115-c may transmit the indication of RLF based on the one or more consecutive indications of CLI. Additionally, or alternatively, the UE 115-c may transmit the indication of RLF based on an expiration of the first timer (or the one or more second timers, or both).

At 345, the UE 115-c may perform a cell reselection procedure associated with a set of network entities 105 in accordance with the indication of radio link failure. For the cell reselection procedure, the UE 115-c may restrict the network entity 105-c from the set of network entities 105 based on the RLF being associated with the communication link between the network entity 105-c and the UE 115-c due to CLI. Accordingly, the process flow 300 may support techniques that result in reduced signal interference between devices, improved coordination between devices, and more efficient use of communication resources, among other advantages.

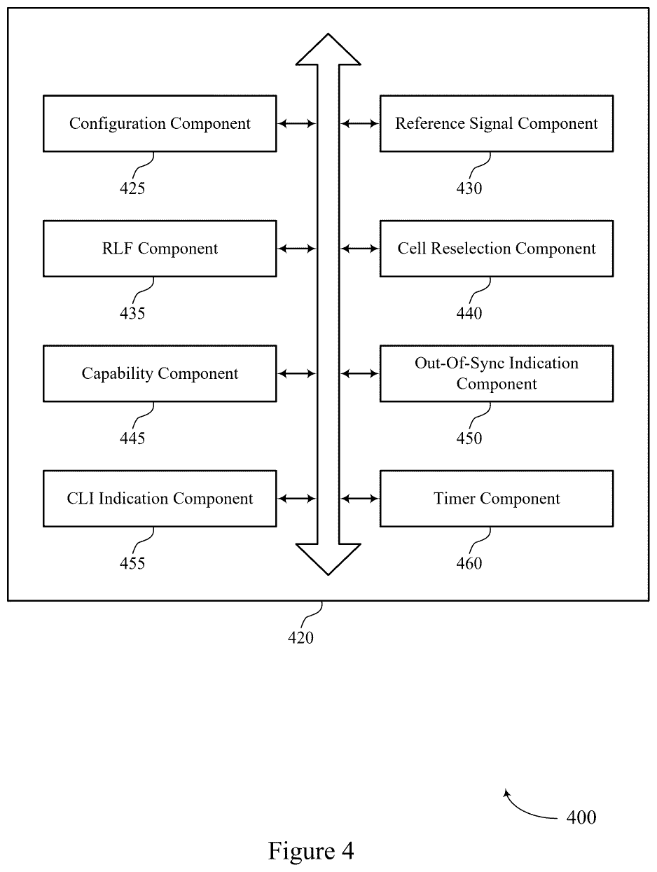

FIG. 4 shows an example of a processing system 420 that supports RLM based on CLI reference signals. A processing system 420 may be an example of a processing system 140 (such as of a UE 115) and may include a configuration component 425, a reference signal component 430, an RLF component 435, a cell reselection component 440, a capability component 445, an out-of-sync indication component 450, a CLI indication component 455, a timer component 460, or any combination thereof. A processing system 420, or various component thereof, may be an example of means for performing (such as a means for causing a UE 115 to perform) various techniques described herein.

The configuration component 425 may be configured to cause the UE 115 to receive configuration information associated with a set of first reference signals to be transmitted by one or more second UEs, where the set of first reference signals are associated with measurement of CLI by the first UE. The reference signal component 430 may be configured to cause the UE 115 to monitor for the set of first reference signals from the one or more second UEs in accordance with the configuration information. The RLF component 435 may be configured to cause the UE 115 to transmit, to a network entity, an indication of RLF associated with a communication link between the network entity and the first UE based on measurement of the set of first reference signals.

In some examples, to support transmitting the indication of RLF, the RLF component 435 may be configured to cause the UE 115 to transmit the indication of RLF based on one or more metrics associated with at least one first reference signal of the set of first reference signals satisfying one or more first thresholds, where the one or more metrics are based on measurement of the set of first reference signals.

In some examples, the reference signal component 430 may be configured to cause the UE 115 to monitor, from the network entity via the communication link, for a set of second reference signals, where the set of second reference signals are associated with one or more second thresholds for detection of RLF on the communication link.

In some examples, the one or more first thresholds are the same as the one or more second thresholds.

In some examples, the one or more first thresholds are different than the one or more second thresholds.

In some examples, the one or more first thresholds are based on one or more first BLER thresholds associated with the set of first reference signals. In some examples, the one or more second thresholds are based on one or more second BLER thresholds associated with the set of second reference signals. In some examples, the one or more first thresholds are different than the one or more second thresholds based on the one or more first BLER thresholds being different than the one or more second BLER thresholds.

In some examples, the out-of-sync indication component 450 may be configured to cause the UE 115 to transmit, from a physical layer of the first UE to a radio resource control layer of the first UE, one or more consecutive out-of-sync indications based on the one or more metrics satisfying the one or more first thresholds, where transmission of the indication of RLF is based on a quantity of the one or more consecutive out-of-sync indications exceeding a second threshold.

In some examples, the CLI indication component 455 may be configured to cause the UE 115 to transmit, from a physical layer of the first UE to a radio resource control layer of the first UE, one or more consecutive indications of detected CLI associated with the one or more second UEs based on the one or more metrics satisfying the one or more first thresholds, where transmission of the indication of RLF is based on the one or more consecutive indications of CLI.

In some examples, the timer component 460 may be configured to cause the UE 115 to start, at the radio resource control layer, a first timer based on receipt of the one or more consecutive indications of detected CLI, where transmission of the indication of RLF is based on an expiration of the first timer.

In some examples, the first timer is further associated with detection of RLF based on a set of second reference signals received from the network entity.

In some examples, the first timer is different than a second timer associated with detection of RLF based on a set of second reference signals received from the network entity.

In some examples, the configuration information indicates one or more resources that the first UE is to use for monitoring for the set of first reference signals. In some examples, monitoring for the set of first reference signals is via the one or more resources.

In some examples, the one or more resources are restricted from being scheduled with one or more downlink messages, one or more uplink messages, or both, based on the one or more resources being used for the monitoring of the set of first reference signals.

In some examples, to support transmitting the indication of RLF, the RLF component 435 may be configured to cause the UE 115 to transmit an RLF report message indicative of a cause value associated with the RLF, where the cause value indicates the RLF is based on CLI associated with the set of first reference signals.

In some examples, the cell reselection component 440 may be configured to cause the UE 115 to perform, in accordance with the indication of RLF, a cell reselection procedure associated with a set of multiple network entities, where the network entity is restricted from set of multiple network entities based on the RLF being associated with the communication link between the network entity and the first UE.

In some examples, the capability component 445 may be configured to cause the UE 115 to transmit a capability message indicative of one or more capabilities of the first UE to declare RLF based on measurement of the set of first reference signals, where receiving the configuration information is based on transmission of the capability message.

In some examples, the first UE is associated with an NTN. In some examples, the one or more second UEs are associated with a TN. In some examples, the network entity is associated with the NTN.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for RLM based on CLI reference signals, which may result in reduced excess power consumption, more efficient utilization of communication resources, and improved cell reselection capability, among other advantages.

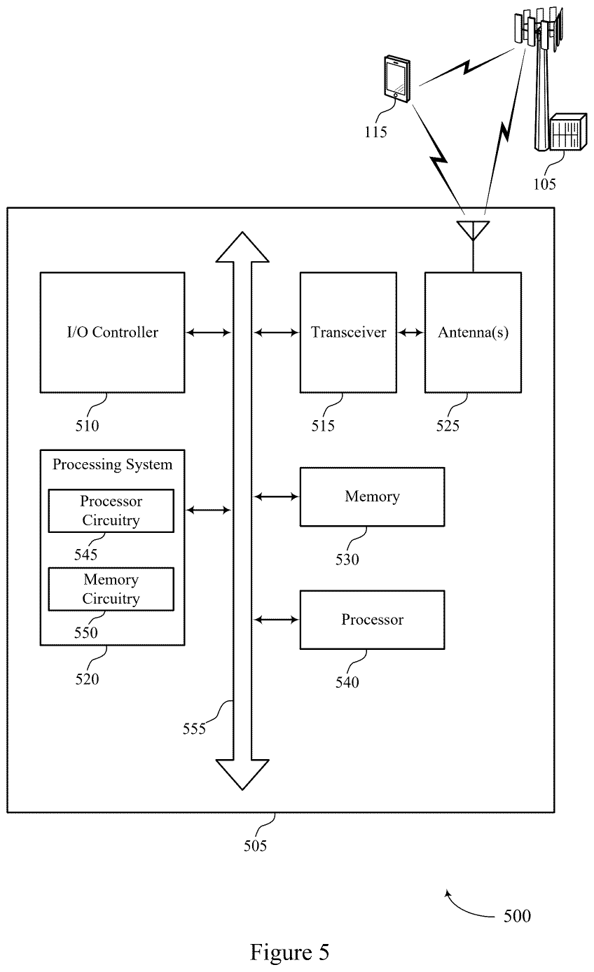

FIG. 5 shows an example of a system 500 including a device 505 that supports RLM based on CLI reference signals. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 400. For example, the processing system 520 may include processor circuitry 545 and memory circuitry 550 that stores code, and may be configured to cause the device 505 to perform operations that support RLM based on CLI reference signals. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for RLM based on CLI reference signals, which may result in improved communication reliability, reduced latency, reduced excess power consumption, more efficient utilization of communication resources, improved coordination between devices, longer battery life, improved utilization of processing capability, and improved cell reselection capability, among other advantages.

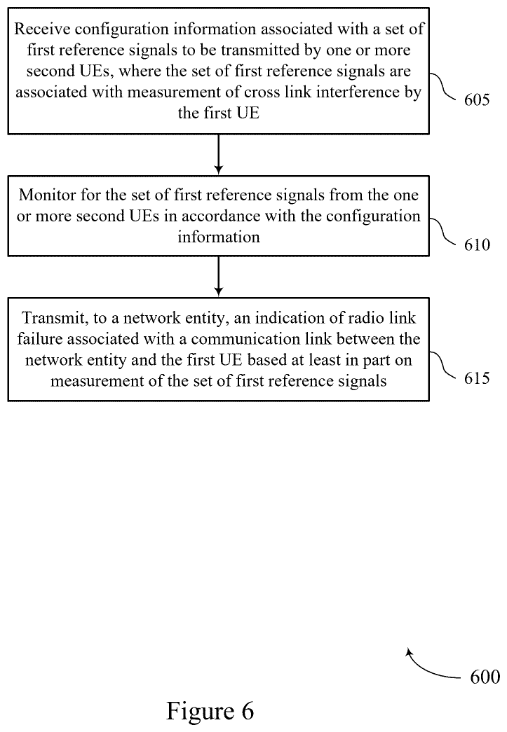

FIG. 6 shows an example of a method 600 that supports RLM based on CLI reference signals. Operations of the method 600 may be performed by a UE or its components (such as using a processing system configured to cause the UE 115 to perform one or more of the operations) as described herein.

At 605, the method may include receiving configuration information associated with a set of first reference signals to be transmitted by one or more second UEs, where the set of first reference signals are associated with measurement of CLI by the first UE. In some examples, aspects of the operations of 605 may be performed by a configuration component 425.

At 610, the method may include monitoring for the set of first reference signals from the one or more second UEs in accordance with the configuration information. In some examples, aspects of the operations of 610 may be performed by a reference signal component 430.

At 615, the method may include transmitting, to a network entity, an indication of RLF associated with a communication link between the network entity and the first UE based at least in part on measurement of the set of first reference signals. In some examples, aspects of the operations of 615 may be performed by an RLF component 435.

Implementation examples are described in the following numbered clauses:
Aspect 1: A method for wireless communications at a first UE, including: receiving configuration information associated with a set of first reference signals to be transmitted by one or more second UEs, where the set of first reference signals are associated with measurement of CLI by the first UE; monitoring for the set of first reference signals from the one or more second UEs in accordance with the configuration information; and transmitting, to a network entity, an indication of RLF associated with a communication link between the network entity and the first UE based on measurement of the set of first reference signals.
Aspect 2: The method of aspect 1, where transmitting the indication of RLF includes: transmitting the indication of RLF based on one or more metrics associated with at least one first reference signal of the set of first reference signals satisfying one or more first thresholds, where the one or more metrics are based on measurement of the set of first reference signals.

Aspect 3: The method of aspect 2, further including: monitoring, from the network entity via the communication link, for a set of second reference signals, where the set of second reference signals are associated with one or more second thresholds for detection of RLF on the communication link.
Aspect 4: The method of aspect 3, where the one or more first thresholds are the same as the one or more second thresholds.
Aspect 5: The method of any of aspects 3 through 4, where the one or more first thresholds are different than the one or more second thresholds.
Aspect 6: The method of aspect 5, where the one or more first thresholds are based on one or more first BLER thresholds associated with the set of first reference signals, the one or more second thresholds are based on one or more second BLER thresholds associated with the set of second reference signals, and the one or more first thresholds are different than the one or more second thresholds based on the one or more first BLER thresholds being different than the one or more second BLER thresholds.
Aspect 7: The method of any of aspects 2 through 6, further including: transmitting, from a physical layer of the first UE to a radio resource control layer of the first UE, one or more consecutive out-of-sync indications based on the one or more metrics satisfying the one or more first thresholds, where transmission of the indication of RLF is based on a quantity of the one or more consecutive out-of-sync indications exceeding a second threshold.
Aspect 8: The method of any of aspects 2 through 7, further including: transmitting, from a physical layer of the first UE to a radio resource control layer of the first UE, one or more consecutive indications of detected CLI associated with the one or more second UEs based on the one or more metrics satisfying the one or more first thresholds, where transmission of the indication of RLF is based on the one or more consecutive indications of CLI.
Aspect 9: The method of aspect 8, further including: starting, at the radio resource control layer, a first timer based on receipt of the one or more consecutive indications of detected CLI, where transmission of the indication of RLF is based on an expiration of the first timer.
Aspect 10: The method of aspect 9, where the first timer is further associated with detection of RLF based on a set of second reference signals received from the network entity.
Aspect 11: The method of any of aspects 9 through 10, where the first timer is different than a second timer associated with detection of RLF based on a set of second reference signals received from the network entity.
Aspect 12: The method of any of aspects 1 through 11, where the configuration information indicates one or more resources that the first UE is to use for monitoring for the set of first reference signals, monitoring for the set of first reference signals is via the one or more resources.
Aspect 13: The method of aspect 12, where the one or more resources are restricted from being scheduled with one or more downlink messages, one or more uplink messages, or both, based on the one or more resources being used for the monitoring of the set of first reference signals.
Aspect 14: The method of any of aspects 1 through 13, where transmitting the indication of RLF includes: transmitting an RLF report message indicative of a cause value associated with the RLF, where the cause value indicates the RLF is based on CLI associated with the set of first reference signals.
Aspect 15: The method of any of aspects 1 through 14, further including: performing, in accordance with the indication of RLF, a cell reselection procedure associated with a set of multiple network entities, where the network entity is restricted from set of multiple network entities based on the RLF being associated with the communication link between the network entity and the first UE.
Aspect 16: The method of any of aspects 1 through 15, further including: transmitting a capability message indicative of one or more capabilities of the first UE to declare RLF based on measurement of the set of first reference signals, where receiving the configuration information is based on transmission of the capability message.
Aspect 17: The method of any of aspects 1 through 16, where the first UE is associated with an NTN, the one or more second UEs are associated with a TN, and the network entity is associated with the NTN.
Aspect 18: A first UE, including: one or more memories storing processor-executable code; and one or more processors coupled with the one or more memories and individually or collectively operable to execute the code to cause the first UE to: receive configuration information associated with a set of first reference signals to be transmitted by one or more second UEs, where the set of first reference signals are associated with measurement of CLI by the first UE; monitor for the set of first reference signals from the one or more second UEs in accordance with the configuration information; and transmit, to a network entity, an indication of RLF associated with a communication link between the network entity and the first UE based on measurement of the set of first reference signals.
Aspect 19: The first UE of aspect 18, where, to transmit the indication of RLF, the one or more processors are individually or collectively operable to execute the code to cause the first UE to: transmit the indication of RLF based on one or more metrics associated with at least one first reference signal of the set of first reference signals satisfying one or more first thresholds, where the one or more metrics are based on measurement of the set of first reference signals.
Aspect 20: The first UE of aspect 19, where the one or more processors are individually or collectively further operable to execute the code to cause the first UE to: monitor, from the network entity via the communication link, for a set of second reference signals, where the set of second reference signals are associated with one or more second thresholds for detection of RLF on the communication link.
Aspect 21: The first UE of aspect 20, where the one or more first thresholds are the same as the one or more second thresholds.
Aspect 22: The first UE of any of aspects 20 through 21, where the one or more first thresholds are different than the one or more second thresholds.
Aspect 23: The first UE of aspect 22, where the one or more first thresholds are based on one or more first BLER thresholds associated with the set of first reference signals, the one or more second thresholds are based on one or more second BLER thresholds associated with the set of second reference signals, and the one or more first thresholds are different than the one or more second thresholds based on the one or more first BLER thresholds being different than the one or more second BLER thresholds.
Aspect 24: The first UE of any of aspects 19 through 23, where the one or more processors are individually or collectively further operable to execute the code to cause the first UE to: transmit, from a physical layer of the first UE to a radio resource control layer of the first UE, one or more consecutive out-of-sync indications based on the one or more metrics satisfying the one or more first thresholds, where transmission of the indication of RLF is based on a quantity of the one or more consecutive out-of-sync indications exceeding a second threshold.
Aspect 25: The first UE of any of aspects 19 through 24, where the one or more processors are individually or collectively further operable to execute the code to cause the first UE to: transmit, from a physical layer of the first UE to a radio resource control layer of the first UE, one or more consecutive indications of detected CLI associated with the one or more second UEs based on the one or more metrics satisfying the one or more first thresholds, where transmission of the indication of RLF is based on the one or more consecutive indications of CLI.
Aspect 26: The first UE of aspect 25, where the one or more processors are individually or collectively further operable to execute the code to cause the first UE to: start, at the radio resource control layer, a first timer based on receipt of the one or more consecutive indications of detected CLI, where transmission of the indication of RLF is based on an expiration of the first timer.
Aspect 27: The first UE of aspect 26, where the first timer is further associated with detection of RLF based on a set of second reference signals received from the network entity.
Aspect 28: The first UE of any of aspects 26 through 27, where the first timer is different than a second timer associated with detection of RLF based on a set of second reference signals received from the network entity.
Aspect 29: The first UE of any of aspects 18 through 28, where the configuration information indicates one or more resources that the first UE is to use for monitoring for the set of first reference signals, monitoring for the set of first reference signals is via the one or more resources.
Aspect 30: The first UE of aspect 29, where the one or more resources are restricted from being scheduled with one or more downlink messages, one or more uplink messages, or both, based on the one or more resources being used for the monitoring of the set of first reference signals.
Aspect 31: The first UE of any of aspects 18 through 30, where, to transmit the indication of RLF, the one or more processors are individually or collectively operable to execute the code to cause the first UE to: transmit an RLF report message indicative of a cause value associated with the RLF, where the cause value indicates the RLF is based on CLI associated with the set of first reference signals.
Aspect 32: The first UE of any of aspects 18 through 31, where the one or more processors are individually or collectively further operable to execute the code to cause the first UE to: perform, in accordance with the indication of RLF, a cell reselection procedure associated with a set of multiple network entities, where the network entity is restricted from set of multiple network entities based on the RLF being associated with the communication link between the network entity and the first UE.
Aspect 33: The first UE of any of aspects 18 through 32, where the one or more processors are individually or collectively further operable to execute the code to cause the first UE to: transmit a capability message indicative of one or more capabilities of the first UE to declare RLF based on measurement of the set of first reference signals, where receiving the configuration information is based on transmission of the capability message.
Aspect 34: The first UE of any of aspects 18 through 33, where the first UE is associated with an NTN, the one or more second UEs are associated with a TN, and the network entity is associated with the NTN.
Aspect 35: A non-transitory computer-readable medium storing code for wireless communications, the code including instructions executable by one or more processors (e.g., directly, indirectly, after pre-processing, without pre-processing) to: receive configuration information associated with a set of first reference signals to be transmitted by one or more second UEs, where the set of first reference signals are associated with measurement of CLI by the first UE; monitor for the set of first reference signals from the one or more second UEs in accordance with the configuration information; and transmit, to a network entity, an indication of RLF associated with a communication link between the network entity and the first UE based on measurement of the set of first reference signals.
Aspect 36: The non-transitory computer-readable medium of aspect 35, where the instructions to transmit the indication of RLF are executable by the one or more processors to: transmit the indication of RLF based on one or more metrics associated with at least one first reference signal of the set of first reference signals satisfying one or more first thresholds, where the one or more metrics are based on measurement of the set of first reference signals.
Aspect 37: The non-transitory computer-readable medium of aspect 36, where the instructions are further executable by the one or more processors to: monitor, from the network entity via the communication link, for a set of second reference signals, where the set of second reference signals are associated with one or more second thresholds for detection of RLF on the communication link.
Aspect 38: The non-transitory computer-readable medium of aspect 37, where the one or more first thresholds are the same as the one or more second thresholds.
Aspect 39: The non-transitory computer-readable medium of any of aspects 37 through 38, where the one or more first thresholds are different than the one or more second thresholds.
Aspect 40: The non-transitory computer-readable medium of aspect 39, where the one or more first thresholds are based on one or more first BLER thresholds associated with the set of first reference signals, the one or more second thresholds are based on one or more second BLER thresholds associated with the set of second reference signals, and the one or more first thresholds are different than the one or more second thresholds based on the one or more first BLER thresholds being different than the one or more second BLER thresholds.
Aspect 41: The non-transitory computer-readable medium of any of aspects 36 through 40, where the instructions are further executable by the one or more processors to: transmit, from a physical layer of the first UE to a radio resource control layer of the first UE, one or more consecutive out-of-sync indications based on the one or more metrics satisfying the one or more first thresholds, where transmission of the indication of RLF is based on a quantity of the one or more consecutive out-of-sync indications exceeding a second threshold.
Aspect 42: The non-transitory computer-readable medium of any of aspects 36 through 41, where the instructions are further executable by the one or more processors to: transmit, from a physical layer of the first UE to a radio resource control layer of the first UE, one or more consecutive indications of detected CLI associated with the one or more second UEs based on the one or more metrics satisfying the one or more first thresholds, where transmission of the indication of RLF is based on the one or more consecutive indications of CLI.
Aspect 43: The non-transitory computer-readable medium of aspect 42, where the instructions are further executable by the one or more processors to: start, at the radio resource control layer, a first timer based on receipt of the one or more consecutive indications of detected CLI, where transmission of the indication of RLF is based on an expiration of the first timer.
Aspect 44: The non-transitory computer-readable medium of aspect 43, where the first timer is further associated with detection of RLF based on a set of second reference signals received from the network entity.
Aspect 45: The non-transitory computer-readable medium of any of aspects 43 through 44, where the first timer is different than a second timer associated with detection of RLF based on a set of second reference signals received from the network entity.
Aspect 46: The non-transitory computer-readable medium of any of aspects 35 through 45, where the configuration information indicates one or more resources that the first UE is to use for monitoring for the set of first reference signals, monitoring for the set of first reference signals is via the one or more resources.
Aspect 47: The non-transitory computer-readable medium of aspect 46, where the one or more resources are restricted from being scheduled with one or more downlink messages, one or more uplink messages, or both, based on the one or more resources being used for the monitoring of the set of first reference signals.
Aspect 48: The non-transitory computer-readable medium of any of aspects 35 through 47, where the instructions to transmit the indication of RLF are executable by the one or more processors to: transmit an RLF report message indicative of a cause value associated with the RLF, where the cause value indicates the RLF is based on CLI associated with the set of first reference signals.
Aspect 49: The non-transitory computer-readable medium of any of aspects 35 through 48, where the instructions are further executable by the one or more processors to: perform, in accordance with the indication of RLF, a cell reselection procedure associated with a set of multiple network entities, where the network entity is restricted from set of multiple network entities based on the RLF being associated with the communication link between the network entity and the first UE.
Aspect 50: The non-transitory computer-readable medium of any of aspects 35 through 49, where the instructions are further executable by the one or more processors to: transmit a capability message indicative of one or more capabilities of the first UE to declare RLF based on measurement of the set of first reference signals, where receiving the configuration information is based on transmission of the capability message.
Aspect 51: The non-transitory computer-readable medium of any of aspects 35 through 50, where the first UE is associated with an NTN, the one or more second UEs are associated with a TN, and the network entity is associated with the NTN.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies, including future systems and radio technologies, not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code) stored in memory circuitry or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
receive configuration information associated with a set of first reference signals to be transmitted by one or more second UEs, wherein the set of first reference signals are associated with measurement of cross link interference by the first UE;
monitor for the set of first reference signals from the one or more second UEs in accordance with the configuration information; and
transmit, to a network entity, an indication of radio link failure associated with a communication link between the network entity and the first UE based at least in part on measurement of the set of first reference signals.

2. The first UE of claim 1, wherein, to transmit the indication of radio link failure, the one or more processors are individually or collectively operable to execute the code to cause the first UE to:
transmit the indication of radio link failure based at least in part on one or more metrics associated with at least one first reference signal of the set of first reference signals satisfying one or more first thresholds, wherein the one or more metrics are based at least in part on measurement of the set of first reference signals.

3. The first UE of claim 2, wherein the one or more processors are individually or collectively further operable to execute the code to cause the first UE to:
monitor, from the network entity via the communication link, for a set of second reference signals, wherein the set of second reference signals are associated with one or more second thresholds for detection of radio link failure on the communication link.

4. The first UE of claim 3, wherein the one or more first thresholds are the same as the one or more second thresholds.

5. The first UE of claim 3, wherein the one or more first thresholds are different than the one or more second thresholds.

6. The first UE of claim 5, wherein:
the one or more first thresholds are based at least in part on one or more first block error rate thresholds associated with the set of first reference signals,
the one or more second thresholds are based at least in part on one or more second block error rate thresholds associated with the set of second reference signals, and
the one or more first thresholds are different than the one or more second thresholds based at least in part on the one or more first block error rate thresholds being different than the one or more second block error rate thresholds.

7. The first UE of claim 2, wherein the one or more processors are individually or collectively further operable to execute the code to cause the first UE to:
transmit, from a physical layer of the first UE to a radio resource control layer of the first UE, one or more consecutive out-of-sync indications based at least in part on the one or more metrics satisfying the one or more first thresholds, wherein transmission of the indication of radio link failure is based at least in part on a quantity of the one or more consecutive out-of-sync indications exceeding a second threshold.

8. The first UE of claim 2, wherein the one or more processors are individually or collectively further operable to execute the code to cause the first UE to:
transmit, from a physical layer of the first UE to a radio resource control layer of the first UE, one or more consecutive indications of detected cross link interference associated with the one or more second UEs based at least in part on the one or more metrics satisfying the one or more first thresholds, wherein transmission of the indication of radio link failure is based at least in part on the one or more consecutive indications of cross link interference.

9. The first UE of claim 8, wherein the one or more processors are individually or collectively further operable to execute the code to cause the first UE to:
start, at the radio resource control layer, a first timer based at least in part on receipt of the one or more consecutive indications of detected cross link interference, wherein transmission of the indication of radio link failure is based at least in part on an expiration of the first timer.

10. The first UE of claim 9, wherein the first timer is further associated with detection of radio link failure based on a set of second reference signals received from the network entity.

11. The first UE of claim 9, wherein the first timer is different than a second timer associated with detection of radio link failure based on a set of second reference signals received from the network entity.

12. The first UE of claim 1, wherein:
the configuration information indicates one or more resources that the first UE is to use for monitoring for the set of first reference signals, and
monitoring for the set of first reference signals is via the one or more resources.

13. The first UE of claim 12, wherein the one or more resources are restricted from being scheduled with one or more downlink messages, one or more uplink messages, or both, based at least in part on the one or more resources being used for the monitoring of the set of first reference signals.

14. The first UE of claim 1, wherein, to transmit the indication of radio link failure, the one or more processors are individually or collectively operable to execute the code to cause the first UE to:
transmit a radio link failure report message indicative of a cause value associated with the radio link failure, wherein the cause value indicates the radio link failure is based at least in part on cross link interference associated with the set of first reference signals.

15. The first UE of claim 1, wherein the one or more processors are individually or collectively further operable to execute the code to cause the first UE to:
perform, in accordance with the indication of radio link failure, a cell reselection procedure associated with a plurality of network entities, wherein the network entity is restricted from plurality of network entities based at least in part on the radio link failure being associated with the communication link between the network entity and the first UE.

16. The first UE of claim 1, wherein the one or more processors are individually or collectively further operable to execute the code to cause the first UE to:
transmit a capability message indicative of one or more capabilities of the first UE to declare radio link failure based at least in part on measurement of the set of first reference signals, wherein receiving the configuration information is based at least in part on transmission of the capability message.

17. The first UE of claim 1, wherein:
the first UE is associated with a non-terrestrial network,
the one or more second UEs are associated with a terrestrial network, and
the network entity is associated with the non-terrestrial network.

18. A method for wireless communications at a first user equipment (UE), comprising:
receiving configuration information associated with a set of first reference signals to be transmitted by one or more second UEs, wherein the set of first reference signals are associated with measurement of cross link interference by the first UE;
monitoring for the set of first reference signals from the one or more second UEs in accordance with the configuration information; and
transmitting, to a network entity, an indication of radio link failure associated with a communication link between the network entity and the first UE based at least in part on measurement of the set of first reference signals.

19. The method of claim 18, wherein transmitting the indication of radio link failure comprises:
transmitting the indication of radio link failure based at least in part on one or more metrics associated with at least one first reference signal of the set of first reference signals satisfying one or more first thresholds, wherein the one or more metrics are based at least in part on measurement of the set of first reference signals.

20. A non-transitory computer-readable medium storing code for wireless communications at a first user equipment (UE), the code comprising instructions executable by one or more processors to:
receive configuration information associated with a set of first reference signals to be transmitted by one or more second UEs, wherein the set of first reference signals are associated with measurement of cross link interference by the first UE;
monitor for the set of first reference signals from the one or more second UEs in accordance with the configuration information; and
transmit, to a network entity, an indication of radio link failure associated with a communication link between the network entity and the first UE based at least in part on measurement of the set of first reference signals.
